(19) United States
(12) Patent Application Publication
(10) Pub. No.: US 2025/0138177 A1
(43) Pub. Date: May 1, 2025

(54) OBJECT TRACKING DEVICE

(71) Applicant: DENSO CORPORATION, Kariya-city (JP)

(72) Inventors: Masaki YONEDA, Nisshin-shi (JP); Takashi OGAWA, Nisshin-shi (JP)

(21) Appl. No.: 19/005,635

(22) Filed: Dec. 30, 2024

Related U.S. Application Data
(63) Continuation of application No. PCT/JP2023/023958, filed on Jun. 28, 2023.

(30) Foreign Application Priority Data
Jul. 1, 2022 (JP) 2022-107182

(51) Int. Cl. G01S 13/72; G01S 13/931

(52) U.S. Cl. CPC G01S 13/723; G01S 13/931; G01S 2013/9323

(57) ABSTRACT

An object tracking device includes: an observation point extractor extracting, based on a state quantity of a target estimated during a previous cycle, an observation point obtained from the target during a current cycle, a prediction point generator generating, based on the state quantity of the target estimated during the previous cycle, a prediction point at a predicted position at which the observation point is expected, an aligner bringing the observation point obtained from the target during the current cycle and the prediction point generated by the prediction point generator into alignment by scan matching, and a residual calculator obtaining a correspondence point of the target at the predicted position corresponding to the observation point from the prediction point brought into alignment with the observation point obtained during the current cycle and calculating a residual between the observation point and the correspondence point.

### CROSS-REFERENCE TO RELATED APPLICATION

The present application is a continuation application of International Application No. PCT/JP2023/023958, filed on Jun. 28, 2023, which claims priority to Japanese Patent Application No. 2022-107182, filed on Jul. 1, 2022. The contents of these applications are incorporated herein by reference in their entirety.

### BACKGROUND

### Technical Field

The present disclosure relates to a technology to track an object such as a vehicle.

### Background Art

A mass point tracking technology has been known as a technology to track an object (i.e., a target), such as another vehicle around an own vehicle, with use of a sensor such as a radar. In the mass point tracking technology, a target is assumed to be a single mass point and tracked as illustrated on the left side in an upper drawing in FIG. 17.

### SUMMARY

In the present disclosure, provided is an object tracking device as the following.

The object tracking device includes: an observation point extractor configured to extract, based on a state quantity of an object estimated during a previous cycle, an observation point obtained from the object during a current cycle; a prediction point generator configured to generate, based on the state quantity of the object estimated during the previous cycle, at least one prediction point at a predicted position at which the observation point is expected; an aligner configured to bring the observation point obtained from the object during the current cycle and the prediction point generated by the prediction point generator into alignment by scan matching, and a residual calculator configured to obtain a correspondence point of the object at the predicted position corresponding to the observation point from the prediction point brought into alignment with the observation point obtained during the current cycle and calculate a residual between the observation point and the correspondence point.

### BRIEF DESCRIPTION OF THE DRAWINGS

FIG. 1 is a block diagram of an overall configuration of an object tracking device of a first embodiment.

FIG. 2 is a block diagram functionally illustrating the object tracking device of the first embodiment.

FIG. 3 is a flowchart indicating a control process of the object tracking device of the first embodiment.

FIG. 4 is an explanatory diagram of, out of steps of object tracking of the first embodiment, a step S100 in FIG. 3.

FIG. 5 is an explanatory diagram of, out of the steps of object tracking of the first embodiment, a step S110 in FIG. 3.

FIG. 6 is an explanatory diagram of, out of the steps of object tracking of the first embodiment, a step S120 in FIG. 3.

FIG. 7 is an explanatory diagram of, out of the steps of object tracking of the first embodiment, a step S130 in FIG. 3.

FIG. 8 is an explanatory diagram of, out of the steps of object tracking of the first embodiment, a step S140 in FIG. 3.

FIG. 9 is an explanatory diagram of a method of scan matching.

FIG. 10 is an explanatory diagram of, out of the steps of object tracking of the first embodiment, a step S150 in FIG. 3.

FIG. 11 is an explanatory diagram of, out of the steps of object tracking of the first embodiment, a step S160 in FIG. 3.

FIG. 12 is an explanatory diagram of a method of calculating a residual vector.

FIG. 13 is an explanatory diagram of a method of updating a state quantity.

FIG. 14A is an explanatory diagram of a method of scan matching for object tracking of a second embodiment and FIG. 14B is an explanatory diagram of an unfavorable method of scan matching.

FIG. 15 is an explanatory diagram of, out of steps of object tracking of a third embodiment, a state with a smaller extent of observation points.

FIG. 16 is an explanatory diagram of, out of the steps of object tracking of the third embodiment, a relationship between an area of a rectangle and a covariance of the observation points.

FIGS. 17A to 17C are a joint explanatory diagram of a typical technology.

### DETAILED DESCRIPTION OF THE PREFERRED EMBODIMENTS

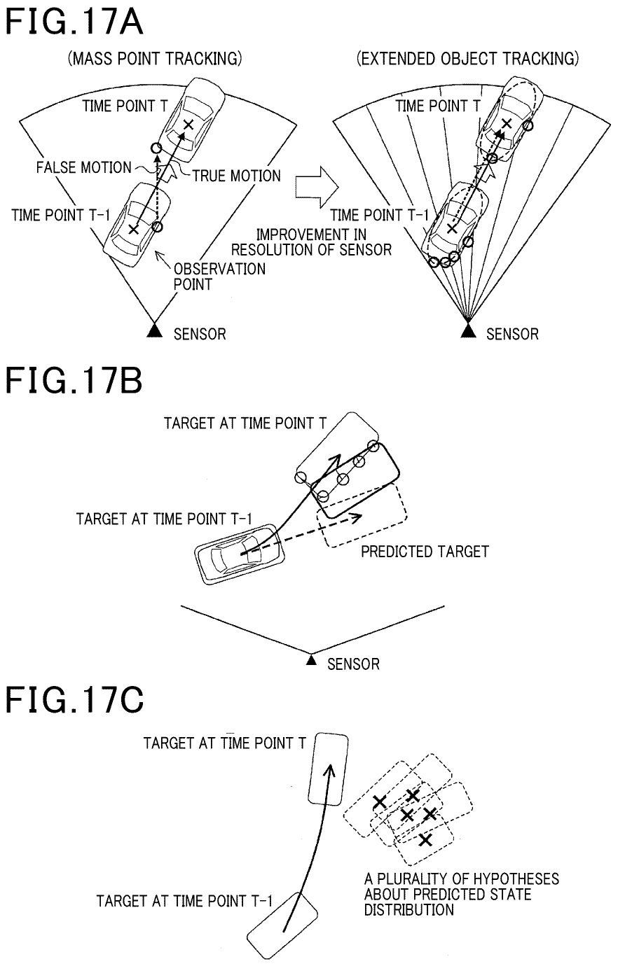

Extended object tracking (i.e., EOT) has also recently been known. In EOT, not only a driven state of a target but also a shape of the target is introduced into a model to perform tracking as illustrated on the right side in the upper drawing in FIG. 17 in order to improve a problem of the mass point tracking (i.e., a problem of tracking becoming unstable). It should be noted that EOT is an abbreviation of Extended Object Tracking and this technology is disclosed in, for example, NPL 1 or the like.

However, as for the technology of extended object tracking, if a motion of a target or an own vehicle rapidly changes or observation information regarding the target is not sufficient, for example, as in an early stage in the course of tracking as illustrated in a middle drawing in in FIG. 17, the target sometimes fails to be tracked accurately.

Proposed as measures against the above problem is, for example, a technology described in PTL 1 below. This technology may be a technology in which a deterioration in tracking accuracy due to sparse observation information and a failure in tracking are reduced by defining, as a likelihood function, the certainty of an observation point from a state distribution of a tracking target predicted at a time point and updating the state distribution after the likelihood function is corrected (i.e., a weight is adjusted) in accordance with the number of observation points as illustrated in a lower drawing in FIG. 17.

The gazette of PTL 1 describes that a predicted distribution obtainable through a particle filter is developed to deal with the occurrence of a prediction error. In other words, a plurality of hypotheses about the predicted state distribution to improve tracking performance (for example, an improvement in tracking loss or the like).
[NPL 1] K. Granstrom, M. Baum, and S. Reuter, “Extended object tracking: Intro-duction, overview, and applications,” Journal of Advances in Information Fusion, vol. 12, no. 2, 2017.
[PTL 1] JP 2021-67482 A

As a result of a detailed study by the inventors, the following problem of the typical technology has been found.

Specifically, the technology according to PTL 1 is disadvantageous in that a computing load is increased due to the generation of a plurality of hypotheses about a predicted state distribution.

In other words, since an electronic control device such as a computer in an own vehicle is limited in its computing power, generating a plurality of hypotheses about a predicted state distribution as described above is disadvantageous in that a computing load is increased.

That is to say, in a case where computing is performed by an electronic control device, the number of hypotheses to be generated is limited due to limitation in calculation amount. Thus, there is a limit on a range of prediction deviation that can be dealt with, which makes it difficult to perform highly accurate tracking. In particular, a high-dimensional state vector indicating a state quantity of a target is disadvantageous in that a range of prediction deviation is noticeably narrowed.

It is desirable that an aspect of the present disclosure provide a technology enabling accurate tracking of an object and achieving a reduction in computing load for tracking the object. An aspect of the present disclosure is directed to an object tracking device (1) configured to cause a sensor (5) to perform sensing of a surrounding environment in a predetermined cycle and track an object (3) that is a target based on information obtained by the sensing.

The object tracking device includes a tracking processing section (9). The tracking processing section is configured to estimate a state quantity indicating a state of the object during a current cycle by using information regarding an observation point indicating the object obtained by the sensor. As the state quantity of the object, the state quantity regarding at least a position of the object and a shape of the object is used.

The tracking processing section (9) includes an observation point extractor (31), a prediction point generator (33), an aligner (35), a residual calculator (37), and a state updater (39).

The tracking processing section is configured to estimate a state quantity indicating a state of the object during a current cycle by using information regarding an observation point indicating the object obtained by the sensor.

The observation point extractor is configured to extract, based on a state quantity of the object estimated during a previous cycle (i.e., a cycle immediately before the current cycle), the observation point obtained from the object during the current cycle. It should be noted that all the obtained observation points may be extracted during an initial cycle.

The prediction point generator is configured to generate, based on the state quantity of the object estimated during the previous cycle, at least one prediction point at a predicted position at which the observation point is expected.

The aligner is configured to bring the observation point obtained from the object during the current cycle and the prediction point generated by the prediction point generator into alignment by scan matching.

The residual calculator is configured to obtain a correspondence point of the object at the predicted position corresponding to the observation point from the prediction point brought into the alignment with the observation point obtained during the current cycle, and calculate a residual between the observation point and the correspondence point.

The state updater is configured to update the state quantity of the object based on the residual calculated by the residual calculator.

Such a configuration enables the object tracking device of the aspect of the present disclosure to accurately track the object with a reduced computing load for tracking the object.

In other words, in the present disclosure, a residual given by calculating an offset (i.e., a correspondence relationship) between the observation point and a predicted shape (i.e., the prediction point) is used instead of making a prediction for a plurality of times as before, which makes it possible to efficiently perform computing for tracking the object. Therefore, the computing load when tracking the object can be reduced, and the object can be tracked suitably.

Moreover, reference signs written in parentheses in this section merely indicate a correspondence relationship with a specific means according to an embodiment described later as one aspect and by no means limit a technical scope of the present disclosure.

An exemplary embodiment of the present disclosure will be described below with reference to the drawings.

### 1. First Embodiment

In the present first embodiment, description will be made by taking an object tracking device installed to a vehicle (for example, an own vehicle) as an example. That is to say, description will be given by taking, as an example, an object tracking device that causes a sensor to perform scanning (i.e., sensing) of a surrounding environment around an own vehicle in a predetermined cycle and performs tracking of an object, which is a target, based on information obtained by the sensing.

### 1-1. Overall Configuration

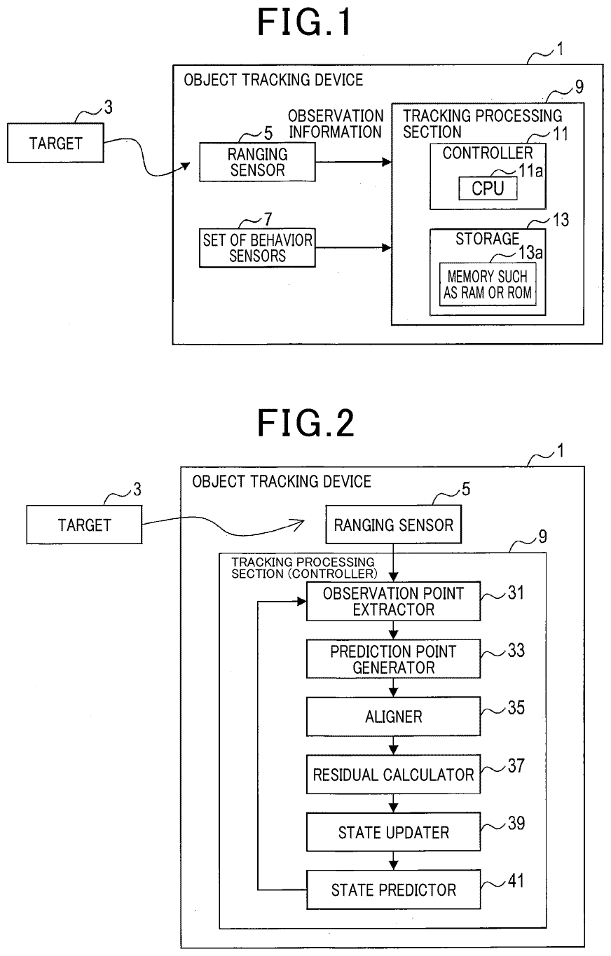

First, description will be made on an overall configuration of an object tracking device 1 of the present first embodiment based on FIG. 1.

As illustrated in FIG. 1, the object tracking device 1 is a device installed to a vehicle (for example, an own vehicle) to track an object (i.e., a target) 3, such as another vehicle, around the own vehicle.

In other words, the object tracking device 1 is a device that achieves EOT, in which the target 3 having an extent is identified from at least one observation point at which the target 3 is observed and then a tracking process for the target 3 is performed as described later in detail.

It should be noted that although exemplified here by a vehicle such as an automobile, the target 3 may be exemplified by a moving object such as a motorcycle or a pedestrian in addition to the above. Moreover, the target 3 may be exemplified by a motionless object having a certain shape.

The object tracking device 1 includes, for example, a ranging sensor 5, which is a surrounding sensor that performs sensing of the surrounding of the own vehicle, a set of behavior sensors 7 that detects a state of the own vehicle, a tracking processing section 9 that performs a process for performing tracking of the target 3, and the like.

Examples of the ranging sensor 5 include a variety of sensors that enable providing information regarding a position of the target 3, for example, a distance between the object tracking device 1 and the target 3 and information regarding a direction of the target 3 relative to the object tracking device 1.

The ranging sensor 5 may be exemplified by, for example, at least one of known Radar, LiDAR, Sonar, stereo camera, or monocular camera. It should be noted that a sensor that enables observing three-dimensional information (x, y, z) indicating a position in space or enables observing a Doppler velocity or a signal strength is also usable as the above-described sensor.

The ranging sensor 5 repeats sensing of the target 3 (i.e., detection by scanning with a radar or the like) and observation of a set of reflection points indicating reflecting portions of the target 3 at a predetermined time interval (i.e., in a predetermined cycle). Then, the tracking processing section 9 identifies the set of reflection points obtained by the ranging sensor 5 at a specific time point k as at least one observation point relative to the target 3 at the time point k as described later.

A variety of sensors, such as an inertial measurement unit (i.e., IMU) and odometer, that enable detection of behaviors such as a movement amount of the own vehicle can be used as the set of behavior sensors 7. Examples of the information to be detected by the set of behavior sensors 7 include an operation amount of an accelerator pedal, an operation amount of a brake pedal, a steering angle, a vehicle velocity, and a vehicle acceleration.

The tracking processing section 9 is an electronic control device mainly including a microcomputer including a controller 11 that performs a variety of processes such as tracking of the target 3 and a storage 13 storing a variety of data and programs.

In detail, the controller 11 may include a known processor (for example, a CPU 11a) and the storage 13 may include, for example, a semiconductor memory (hereinafter, referred to as memory 13a) such as a RAM or a ROM.

A function of the controller 11 is implemented by the CPU 11a executing a program stored in a non-transitory tangible recording medium (i.e., the memory 13a). Moreover, as the program is executed, a method corresponding to the program is executed.

It should be noted that an approach to implementing the various functions of the controller 11 is not limited to software and all or a part of the elements thereof may be implemented by one or a plurality of pieces of hardware. For example, in a case where the above-described function is implemented by an electronic circuit, which is hardware, the electronic circuit may be implemented by a digital circuit including a large number of logic circuits, an analog circuit, or a combination thereof.

### <Functional Configuration of Tracking Processing Section>

Here, description will be given on a functional configuration of the tracking processing section 9. It should be noted that the controller 11 is a section that performs a computing process for tracking.

As illustrated in FIG. 2, the tracking processing section 9 (in detail, the controller 11) functionally includes an observation point extractor 31, a prediction point generator 33, an aligner 35, a residual calculator 37, a state updater 39, and a state predictor 41.

The tracking processing section 9 is configured to estimate a state quantity (i.e., a state vector) with use of the information regarding the observation point, which indicates the target 3, obtained by the ranging sensor 5. The state quantity indicates a state of the target 3 during a current cycle. It should be noted that the state quantity may be a state quantity regarding at least a position of the target 3 and a shape of the target 3.

The observation point extractor 31 is configured to extract, based on the state quantity of the target 3 estimated during a previous cycle (i.e., a cycle immediately before the current cycle), the observation point obtained from the target 3 during the current cycle.

The prediction point generator 33 is configured to generate, based on the state quantity of the target 3 estimated during the previous cycle, at least one prediction point at a predicted position at which the observation point is expected.

The aligner 35 is configured to bring the observation point obtained from the target 3 during the current cycle and the prediction point generated by the prediction point generator 33 into alignment by scan matching.

The residual calculator 37 is configured to obtain a correspondence point of an object at a predicted position corresponding to the observation point from the prediction point brought into alignment with the observation point obtained during the current cycle and calculate a residual (i.e., a residual vector) between the observation point and the correspondence point.

The state updater 39 is configured to update the state quantity of the target 3 based on the residual calculated by the residual calculator 37.

The state predictor 41 is configured to predict a state quantity during a next cycle (i.e., a cycle immediately after the current cycle) based on the state quantity updated by the state updater 39.

### 1-2. Overall Process by Tracking Processing Section

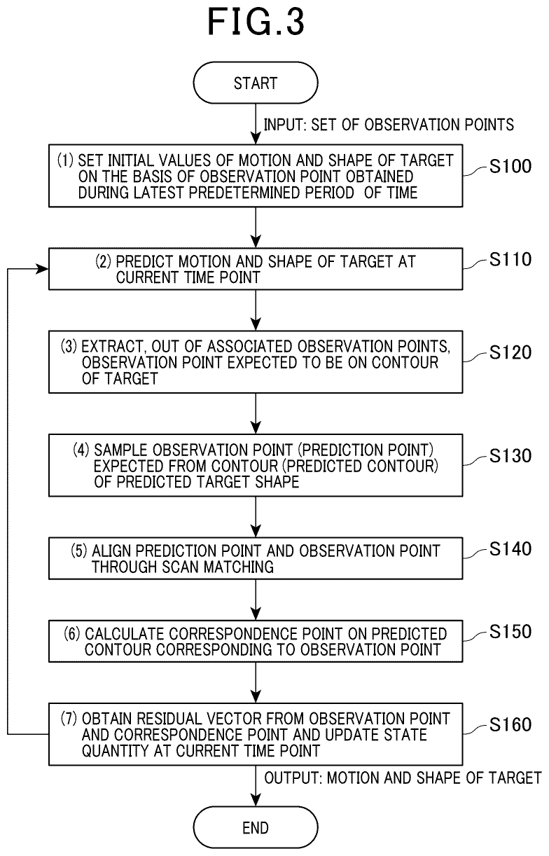

Next, description will be given on schematic steps of an overall process by the object tracking device 1 of the present first embodiment based on a flowchart in FIG. 3. It should be noted that respective contents of the steps will be described later in detail.

First, in Step (hereinafter, S) 100 in FIG. 3, initial values of a motion and a shape of the target 3 are set based on an observation point obtained during a latest predetermined period of time.

In subsequent S110, a motion and a shape of the target 3 at a current time point are predicted.

In subsequent S120, an observation point expected to be on a contour (i.e., an actual contour) of the target 3 is extracted from among associated observation points.

In subsequent S130, an observation point (i.e., a prediction point) expected from a contour (i.e., a predicted contour) of the shape of the predicted target 3 is sampled.

In subsequent S140, the prediction point and the observation point are brought into alignment by scan matching.

In subsequent S150, a correspondence point on the predicted contour and that corresponds to the observation point is calculated.

In subsequent S160, a residual (i.e., a residual vector) is obtained from the observation point and the correspondence point and the state quantity (i.e., the state vector) at the current time point is updated.

After that, the process returns to S110 described above and a similar process is repeated with use of the updated state quantity.

### 1-3. Contents of Processes by Tracking Processing Section

Next, contents of processes (i.e., S100 to S160) by the tracking processing section 9 in FIG. 3 will be described in order in detail.

### (1) Contents of Process in S100

In this step, the initial values of the motion of the target 3 and the shape of the target 3 are to be set based on the observation point obtained during the latest predetermined period of time.

Here, the motion may include a position and a velocity (i.e., a magnitude and a direction of a velocity) of a mass point of the target 3 and the shape may include a size (i.e., a spatial extent of the target 3) and an orientation (i.e., an orientation faced by the target 3 in the shape) of the target 3. It should be noted that since the size of the target 3 is constant, the size (for example, width, depth, and height) and the orientation of the target 3 may be taken into consideration as the shape. It should be noted that examples of the position include coordinates in a predetermined coordinate system (for example, a coordinate system in which north, south, east, and west are defined or a coordinate system based on a predetermined vehicle such as the own vehicle).

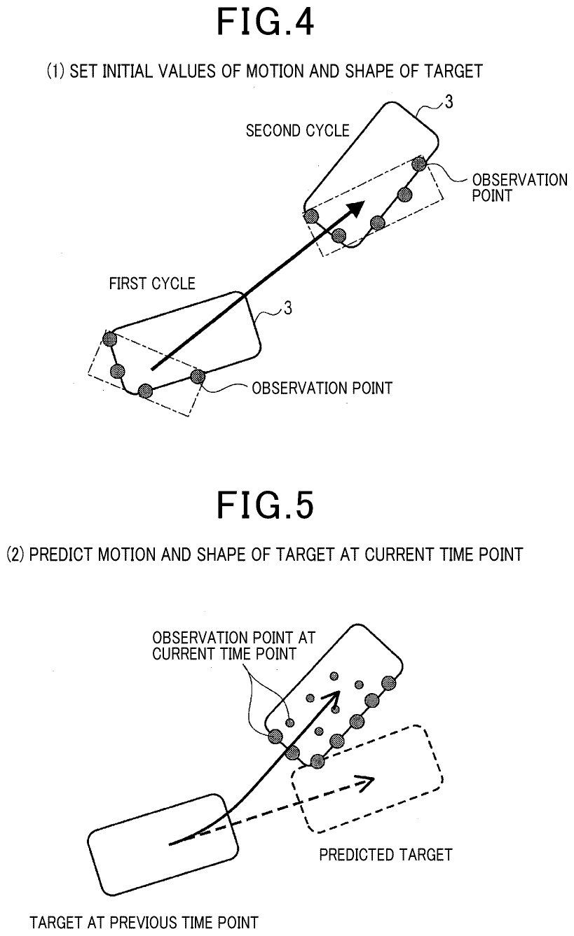

As illustrated in FIG. 4, it is assumed that with use of the ranging sensor 5 such as a radar, for example, a plurality of observation points in the target 3 in the lower left of the drawing are obtained by sensing in a first cycle and a plurality of observation points in the target 3 in the upper right of the drawing are obtained by sensing in a second cycle. It should be noted that the observation points are reflection points of a radar wave or the like in the target 3. In FIG. 4, the observation points are represented as circles that are internally finely hatched. It should be noted that circles that are likewise internally finely hatched also represent observation points in other drawings.

In this case, for example, a position of the target 3 in the first cycle is found from a center of gravity (i.e., a center of gravity 1) of the plurality of observation points in the first cycle and a position of the target 3 in the second cycle is found from a center of gravity r (i.e., a center of gravity 2) of the plurality of observation points in the second cycle. Moreover, the velocity of the target 3 (i.e., the motion of the target 3) is found from a movement vector from the center of gravity 1 to the center of gravity 2.

Moreover, in addition to the above, description will be given on a case where a peripheral shape of the target 3 (i.e., a contour including the size of the target 3) as the target 3 is viewed from above (i.e., in plan view) has been known. In a case where the target 3 has, for example, a rectangular contour as represented as a quadrangular frame in the drawing, the shape (i.e., the size and the orientation) of the target 3 in plan view is found by arranging (i.e., fitting) the plurality of observation points in conformity with the contour of the target 3. That is to say, the shape of the target in plan view is found as represented as the quadrangular frame in the drawing and the centers of gravity of the targets 3 are found from the respective shapes of the targets 3.

As such, the positions of the target 3 are found from the positions of the center of gravity of the target 3 in the first cycle and the second cycle and the motion of the target 3 is found from the movement vector of the center of gravity.

Thus, for example, it is possible to set the center of gravity of the target 3 in the first cycle as the initial value of the position of the target 3 and the velocity obtained from the movement vector of the center of gravity as the initial value of the velocity of the target 3 in the second cycle.

It should be noted that description will be given by taking, as an example of a planar shape of the target 3, a rectangular conformable to, for example, the peripheral shape (i.e., the contour) of the vehicle.

### (2) Contents of Process in S110

In this step, the motion and the shape of the target 3 at the current time point are to be predicted.

As illustrated in FIG. 5, in a case where the position and the velocity of the target 3 at a time point before one cycle (i.e., a previous time point) have been known, the position and the velocity of the target 3 during the current cycle are predictable. It should be noted that the contour of the predicted target is represented by broken lines in the drawing.

In other words, it is possible to find the position of the predicted target 3 by predicting that the target 3 has been moved from the position of the target 3 at the previous time point at the velocity of the target 3 at the previous time point. It should be noted that the velocity at the position of the predicted target 3 may be the velocity at the previous time point.

Moreover, in the drawing, a movement state of the actual target 3 is represented as a solid arrow, observation points actually observed at the current time point are represented as large and small circles, and a contour of the actual target 3 at the current time (i.e., a contour ahead of the tip of the arrow) is represented by solid lines.

It should be noted that out of the plurality of actually observed observation points, the observation point located on the contour of the target 3 is represented larger than the observation point located inside the target 3. It should be noted that a large number of observation points are usually obtainable from the contour (i.e., an outer periphery).

### (3) Contents of Process in S120

In this step, the observation point expected to be on the contour of the target 3 is to be extracted from among the associated observation points.

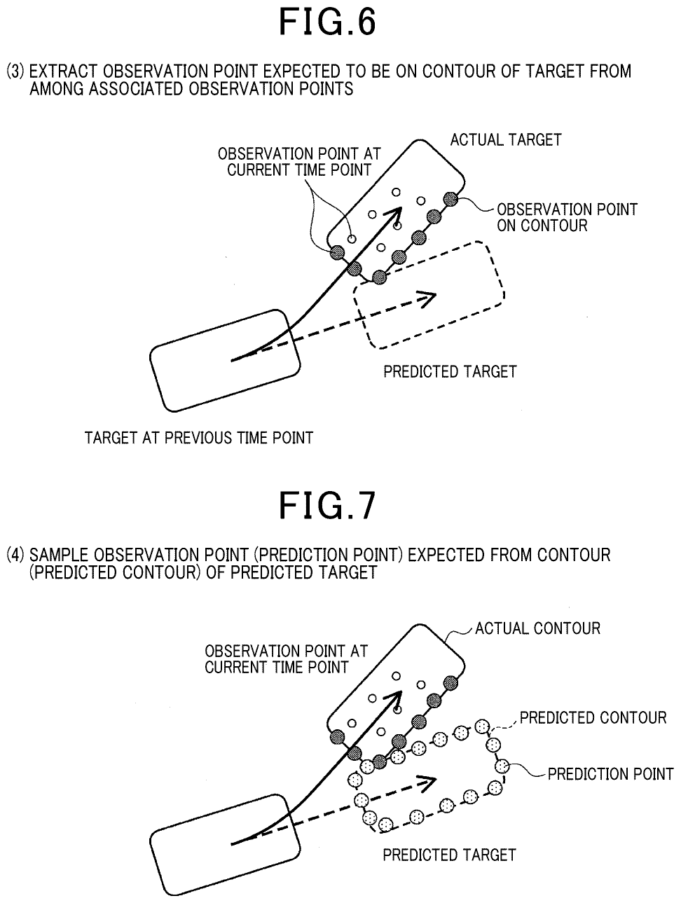

There are cases where the position of the actual target 3 is offset from the position of the predicted target 3 as illustrated in FIG. 6. Accordingly, the position of the actual target 3 is usually estimated to be near the position of the predicted target 3, for example, within a connection range such as a range at a predetermined distance from the predicted target 3.

A plurality of observation points (i.e., observation points depicted as large and small circles in FIG. 6) within the connection range are then selected as the observation points of the actual target 3 at the current time point.

Further, out of these observation points, the observation point (i.e., the observation point depicted as an internally hatched larger circle in FIG. 6) expected to be on the contour (i.e., the actual contour) of the actual target 3 or near the contour is extracted. In other words, since the contour of the target 3 is rectangular, the observation point considered to be on or near the rectangular frame is extracted.

### (4) Contents of Process in S130

In this step, the observation point (i.e., the prediction point) expected from the contour (i.e., the predicted contour) of the predicted target 3 is to be sampled.

Here, prediction points are set on the contour of the predicted target 3 in a shape of a quadrangular frame at predetermined intervals as illustrated in FIG. 7. In FIG. 7, the prediction points are represented as circles internally provided with a plurality of dots. It should be noted that similar circles provided with dots represent prediction points in other drawings.

### (5) Contents of Process in S140

In this step, the prediction points on the predicted contour and the observation points extracted on the actual contour (i.e., the observation points along the actual contour) are brought into alignment by scan matching.

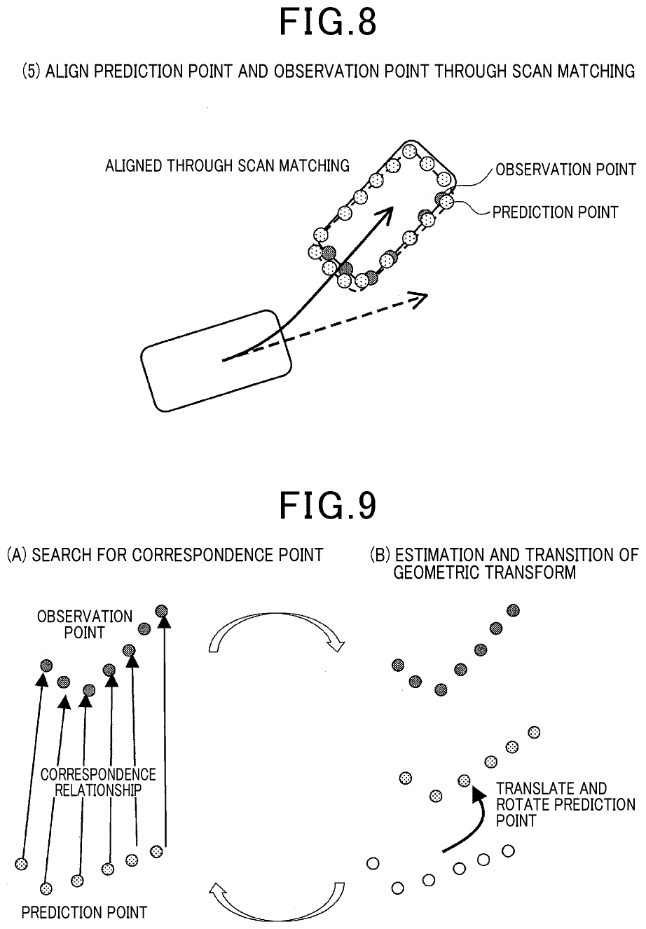

As illustrated in FIG. 8, the prediction point and the observation point are brought into alignment by a known approach to scan matching to cause the predicted contour and the actual contour to overlap each other as much as possible.

For example, a process to translate (i.e., move in parallel) and/or rotate the prediction points so that the prediction points and the observation points have a one-to-one relationship to cause the plurality of observation points and the plurality of prediction points to become as close as possible to each other (i.e., a process of estimation and transition of geometric transform) is performed as illustrated in FIG. 9.

In other words, in order to cause a shape based on an arrangement of the plurality of prediction points (for example, an L-shape) to become as identical as possible to a shape based on an arrangement of the plurality of extracted observation points (for example, an L-shape), for example, the plurality of prediction points are moved with the shape based on the arrangement of the plurality of prediction points being maintained.

Here, description will be given on basic contents of scan matching.

For example, ICP algorithm can be uesd as the approach to scan matching. The ICP algorithm has been widely used as a basic approach to alignment of a three-dimensional shape. The ICP algorithm is an approach in which with the assumption that a set of prediction points is a set of source points and the observation points are a set of target points, a final alignment is performed by alternately repeating two processes, a calculation for association based on the nearest neighbor point and estimation of geometric transform from the correspondence point, until a convergence condition is satisfied.

The approach to scan matching is described in Literature [1] and Literature [2] below. It should be noted that Literature [1] below includes an original paper of the ICP algorithm and Literature [1] describes detailed steps. Moreover, Literature [2] is a tutorial explaining an overview of the ICP algorithm.
Literature [1]: Besl, Paul J. and Neil D. Mckay. “A Method for Registration of 3-D Shapes.” IEEE Trans. Pattern Anal. Mach. Intell. 14 (1992): 239-256.
Literature [2]: Takeshi Masuda, “Icp Algorithm,” Technical Reports of Information Processing Society of Japan, vol. 2009, no. 2, pp. 1-8, 2009.

### (6) Contents of Process in S150

In this step, the correspondence point on the predicted contour corresponding to the observation point is to be obtained by calculation.

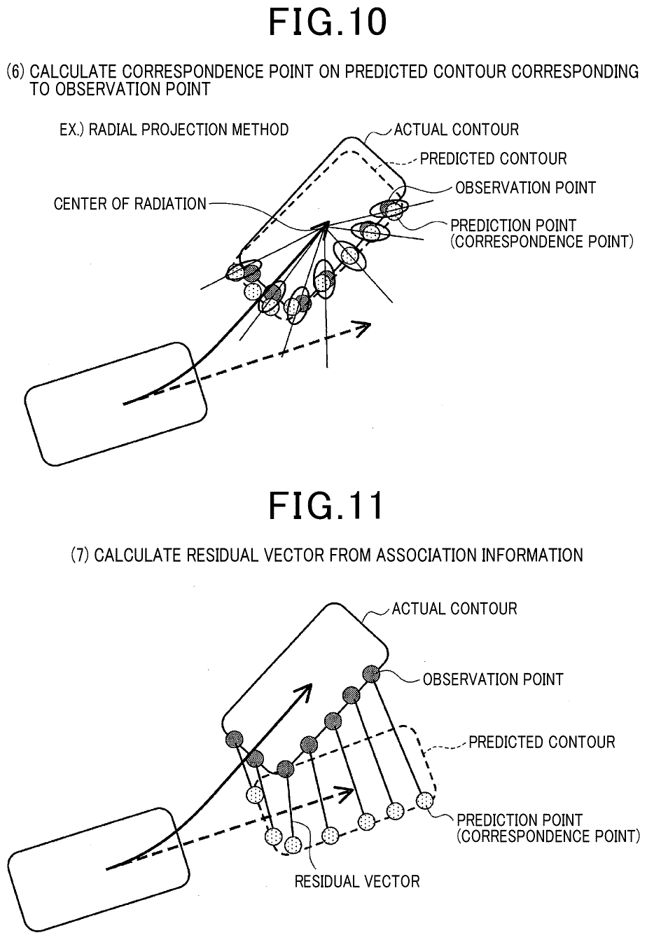

For the scan-matched observation point and prediction point, the prediction point on the predicted contour corresponding to the observation point (i.e., the correspondence point) may be obtained by, for example, a radial projection method as illustrated in FIG. 10.

For example, a straight line may be drawn radially around a position of the mass point of the predicted target 3 toward the observation point on the actual contour and the observation point and the prediction point on the straight line or at the closest position to the straight line are associated with each other on a one-to-one basis.

It should be noted that the radial projection method is, for example, a known technology as described in Literature [3] below.
Literature [3]: M. Michaelis, P. Berthold, T. Luettel, D. Meissner, and H. J. Wuensche, “Extended object tracking with an improved measurement-to-contour association,” Proc. 2020 23rd Int. Conf. Inf. Fusion, FUSION 2020, no. July 2020, doi: 10.23919/FUSION45008.2020.9190439.

The prediction point associated with the observation point is the correspondence point on the predicted contour of the predicted target 3 as illustrated in FIG. 11.

### (7) Contents of Process in S160

In this step, the residual vector is to be obtained from the observation point and the correspondence point (i.e., the prediction point corresponding to the observation point) and the state quantity of the target 3 at the current time point is to be updated as illustrated in FIG. 11.

It should be noted that the state quantity of the target 3 may be represented as a state vector as commonly known.

For example, in a case where the state quantity of the target 3 is represented by a lateral orientation position x, a longitudinal orientation position y, a lateral velocity vx, and a longitudinal velocity vy, the state vector represented as a vector may be represented as X=[x, y, vx, vy] T by using the above state quantities as elements. It should be noted that, for example, the lateral direction is a vehicle-width direction and the longitudinal direction is a direction perpendicular to the vehicle-width direction.

Here, description will be given on the residual vector.

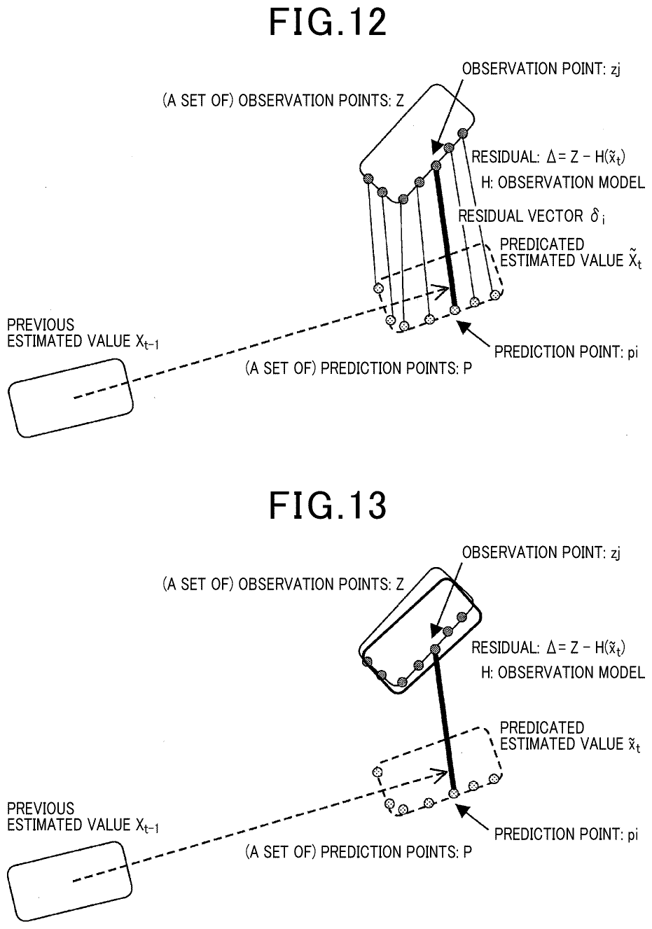

As illustrated in FIG. 12, a residual (i.e., Δ) represented as a matrix is a difference between a predicted value (i.e., a predicted estimated value) xt of the state quantity of the target 3 at the current time point and a value (i.e., an observed value) Z indicating the observation point, represented as Δ=Z−H (xt).

His an observation model. An i-th element of a residual δ becomes a residual vector δi. It should be noted that although the tilde “˜” is appended above ‘x’ of the predicted value xt as illustrated in FIG. 12, it is omitted here.

For example, it is assumed that the prediction points (a set of prediction points) are denoted by P and the i-th point belonging thereto is denoted by pi and the observation points (a set of observation points) are denoted by Z and the j-th point belonging thereto is denoted by zj. It is also assumed that pi and zj are associated with each other from information regarding association obtained in advance. In this situation, the residual vector δI is calculated as δI=zj−pi (i.e., a differential between information possessed by the point zj and information possessed by the point pi: a difference between a vector zj and a vector pi).

Here, examples of the information possessed by pi and zj include position information (x, y) regarding the points. It should be noted that another dimension such as velocity information (vx, vy) regarding the points may be added.

It should be noted that Literature [4] below describes a specific calculation method of obtaining a residual vector from information regarding association in a B-spline model.
Literature [4]: H. Kaulbersch, J. Honer, and M. Baum, “A Cartesian B-Spline Vehicle Model for Extended Object Tracking,” 2018 21st Int. Conf. Inf. Fusion, FUSION 2018, no. December 2019, pp. 1771-1778, 2018, doi: 10.23919/ICIF.2018.8455717.

Moreover, Literature [5] below includes a description about formulation of residual in which velocity information (Doppler Range Rate) regarding a point in a Star-convex model is taken into consideration.
Literature [5]: K. Thormann, M. Baum, and J. Honer, “Extended Target Tracking Using Gaussian Processes with High-Resolution Automotive Radar,” 2018 21st Int. Conf. Inf. Fusion, FUSION 2018, no. December 2019, pp. 1764-1770, 2018, doi: 10.23919/ICIF.2018.8455630.

Next, description will be given on an approach to updating the state quantity at the current time point. Since the approach is a known art (see, for example, JP 2021-4737 A), the description is brief.

As illustrated in FIG. 13, the residual Δ=Z−H (xt) is calculated from the predicted value xt of the state quantity of the target 3 at the current time point and the observed value Z of the observation point, and the state quantity of the object is updated through a known non-linear Kalman filter (for example, an extended Kalman filter or a sigma-point Kalman filter).

Then, after the state quantity at the current time point is updated, the process returns to Step 110 described above and a similar process is repeated using the updated state quantity. In other words, the updated information quantity is used to predict the state quantity of the target 3 during the next cycle.

It should be noted that a process to predict the state quantity of the target 3 during the next cycle is known. For example, the predicted value xt of the state quantity of the target 3 during the next cycle (at a time point t) can be calculated using a state quantity x(t−1) of the target 3 during the previous cycle (at a time point t−1) and a motion model (see Expression [Math. 1] below) representing a state transition of the target 3.

$$Motion Model : {x}_{t} = F ( {x}_{t - 1} , {w}_{t} ) \qquad [ Math . 1 ]$$

$$F : Equation of Motion$$

$${w}_{t} : Process Noise ( Error of Motion Model )$$

### 1-4. Effects

The present first embodiment produces the following effects.

In the present first embodiment, the tracking processing section 9 estimates a state quantity (i.e., a state vector) indicating a state of the target 3 during the current cycle, with use of information regarding an observation point, which indicates the target 3, obtained by the ranging sensor 5. The observation point extractor 31 extracts, based on the state quantity of the target 3 estimated during the previous cycle, the observation point obtained from the target 3 during the current cycle. The prediction point generator 33 generates, based on the state quantity of the target 3 estimated during the previous cycle, at least one prediction point at a predicted position at which the observation point is expected. The aligner 35 performs an alignment of the observation point obtained from the target 3 during the current cycle and the prediction point generated by the prediction point generator 33 by scan matching. The residual calculator 37 obtains a correspondence point of the target 3 at a predicted position corresponding to the observation point from the prediction point brought into alignment with the observation point obtained during the current cycle and calculates a residual (i.e., a residual vector) between the observation point and the correspondence point. The state updater 39 updates the state quantity of the target 3 based on the residual. The state predictor 41 predicts a state quantity during a next cycle based on the updated state quantity.

Such a configuration enables the object tracking device 1 of the present first embodiment to accurately track the target 3 with a reduced computing load for tracking the target 3.

In other words, in the present first embodiment, an offset (i.e., a correspondence relationship) between the observation point and a predicted shape (i.e., the prediction point) is calculated instead of making a prediction for a plurality of times as before, so that it is possible to efficiently perform the calculation. Therefore, it is possible to reduce a computing load for tracking the target 3 and accurately track the target 3.

### 1-5. Correspondence Relationship

Next, description will be given on a relationship between the present first embodiment and the present disclosure.

The object tracking device 1 corresponds to an object tracking device, the target 3 corresponds to a target, the ranging sensor 5 corresponds to a sensor, the tracking processing section 9 corresponds to a tracking processing section, the observation point extractor 31 corresponds to an observation point extractor, the prediction point generator 33 corresponds to a prediction point generator, the aligner 35 corresponds to an aligner, the residual calculator 37 corresponds to a residual calculator, and the state updater 39 corresponds to a state updater.

### 2. Second Embodiment

A second embodiment is similar in basic configuration to the first embodiment and description will be given mainly on a difference from the first embodiment, accordingly. It should be noted that the same reference signs as in the first embodiment denote the same components and reference is made to the preceding explanation.

A hardware configuration of the present second embodiment is the same as that of the first embodiment and the explanation thereof is omitted, accordingly.

The present second embodiment is characterized by an approach to scan matching and the approach to scan matching will be described, accordingly.

In the present second embodiment, in the course of alignment through scan matching, a process to re-examine, out of the predication points generated by the prediction point generator 33, the point observable from the sensor (for example, the ranging sensor 5) is to be sequentially performed. A detailed description is as follows.

### 2-1. Contents of Process

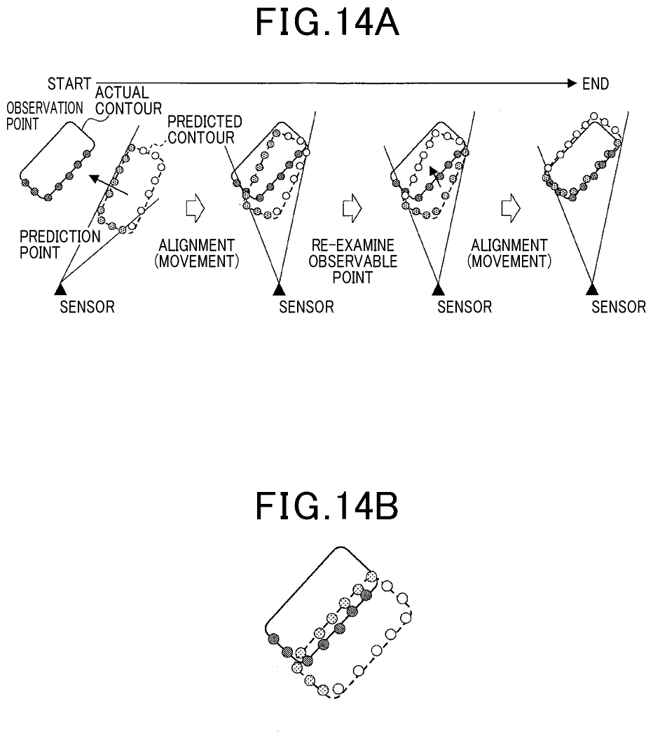

It is assumed that observation points along an actual contour are obtained by sensing and prediction points along a predicted contour (for example, a rectangular frame) are calculated as illustrated in a drawing at the left end in FIG. 14A. Here, for example, the prediction point within a range where a reflected wave is considered to be obtained within a radar wave irradiation range as viewed from the sensor (i.e., the prediction point represented as a circle internally provided with a plurality of dots) is selected from among all the prediction points along the rectangular frame (i.e., the prediction points represented as circles).

Here, in a case where the observation points along the actual contour (i.e., the circles that are internally finely hatched) and the prediction points of the predicted contour (i.e., the circles internally provided with the plurality of dots) are directly brought into alignment by scan matching according to Literature [3] above as illustrated in the drawing at the left end in FIG. 14A, the alignment fails to be appropriately performed in some cases as illustrated in FIG. 14B.

In other words, the observation points of the actual contour are observation points on two side surfaces on the lower-right side of the actual contour, whereas the prediction points of the predicted contour are prediction points on two side surfaces on the left side of the predicted contour; therefore, there are cases in which the observation points and the prediction points fail to be correctly associated even though the observation points and the prediction points are scan-matched.

Accordingly, in the present second embodiment, a process to re-obtain the prediction point that is to be used for scan matching is first performed as illustrated in the second drawing from the left in FIG. 14A.

Specifically, a process to re-obtain, as a prediction point that is to be used for scan matching, a prediction point within a fan-shaped range (for example, the radar-wave irradiation range) that can be directly detected by the sensor is performed. In other words, out of all the prediction points along the predicted contour, a point observable from the sensor is sequentially re-examined.

Then, scan matching is performed with use of the observation points of the actual contour and the re-obtained prediction points of the predicted contour as illustrated in a drawing at the right end in FIG. 14A.

### 2-2. Effects

The present second embodiment produces similar effects to the first embodiment.

The present second embodiment also enables preventing association with a wrong side surface or the like of the target 3 through scan matching. Therefore, it is possible to appropriately calculate a residual, which enables an improvement in tracking accuracy.

It should be noted that although Literature [3] above describes the usage itself of an observable position within the predicted shape (i.e., the predicted contour) of the target 3 for a calculation for association, the present second embodiment is characterized by re-obtaining (sequentially re-examining) a prediction point in the course of scan matching.

### 3. Third Embodiment

A third embodiment is similar in basic configuration to the first embodiment and description will be made mainly on a difference from the first embodiment, accordingly. It should be noted that the same reference sign as in the first embodiment denotes the same component and reference is made to the preceding explanation.

A hardware configuration of the present third embodiment is the same as that of the first embodiment and the explanation thereof is omitted, accordingly.

The present third embodiment is directed to a process for a case where the number of observation points is small.

### 3-1. Contents of Process 1

In one example of the present third embodiment, a spatial extent of points (i.e., a set of observation points) that can be observed from the sensor (for example, the ranging sensor 5) is determined, and in a case where the extent is a narrow range equal to or smaller than a certain level, scan matching is not to be performed. It should be noted that an extent in plan view may be usable as the spatial extent.

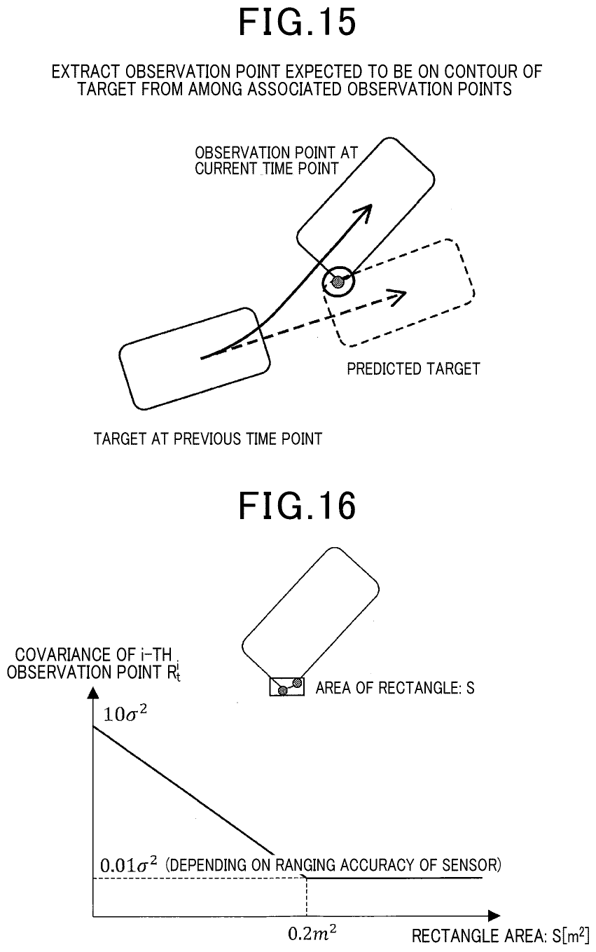

In other words, in a case where the extent of the set of observation points is narrow as illustrated in FIG. 15, there is a possibility that scan matching fails to be appropriately performed due to a difficulty in associating the observation points with the prediction points. Accordingly, in such a case, scan matching is not to be performed.

This makes it possible to reduce the lowering of object tracking performance attributed to an inappropriate scan matching.

### 3-2. Contents of Process 2

In another example of the present third embodiment, a spatial extent of points (i.e., a set of observation points) that can be observed from the sensor is determined, and in a case where the extent is a narrow range equal to or smaller than a certain level, a weight of observation information, which is information regarding the observation points, is lowered in updating the state quantity.

In other words, it is determined that a geometric feature such as the actual contour (for example, the shape of the rectangular frame) is not obtainable and the possibility of failure of scan matching is assumed. In such a case, the weight of the observation information is lowered.

A detailed description is as follows.

It is assumed that observation noise is representable by a covariance matrix Rt and complies with a multivariable normal distribution of zero average. In a case where the observation is independent, the covariance matrix Rt is defined as a diagonal matrix as represented by Expression [Math. 2] below. It should be noted that the observation noise here means, for example, an error of ranging information (for example, an error of distance or error of Doppler velocity) obtainable from the ranging sensor 5.

$${v}_{t} ∼ N ( 0 , {R}_{t} ) \qquad [ Math . 2 ]$$

$${R}_{t} = diag ( {R}_{t}^{1} , {R}_{t}^{2} , … , {R}_{t}^{m} ) m : Number of Observation Points$$

In a case where there is only one observation point, it is possible to determine that there is no spatial extent (i.e., the area is zero), so that a component of the covariance matrix is set at a significantly large value (for example, 1062). In a case where there are two or more points, for example, an area of a rectangle circumscribed to the set of points is calculated and a component of the covariance matrix is adjusted in a relationship as illustrated in, for example, FIG. 16 in accordance with the area.

As such, in a case where it is determined that no geometric feature is obtainable and scan matching results in failure, the observation noise is increased to relatively lower the weight of the observation information and a prediction-oriented estimation is performed (i.e., emphasize the estimation using the prediction points), which makes it possible to improve robustness.

For example, it is possible to lower the weight of the observation information to enable a prediction-oriented estimation by performing a process using Expression [Math. 3] below described in “Proposition 2 (Non-linear Kalman Filter)” of “Basis of Non-linear Kalman Filter” of Literature [6] below (see the URL below).
Literature [6]: https://www.jstage.jst.go.jp/article/sicejl/56/9/56_638/pdf

$$Extended Kalman Filter \qquad [ Math . 3 ]$$

$$Observation Updating Expression$$

$${K}_{k} = {P}_{k / k - I} {{\hat{H}}_{k}^{T} [ {\hat{H}}_{k} {P}_{k / k - 1} {\hat{H}}_{k}^{T} + R ]}^{- 1} \qquad 16 ( a )$$

$${\hat{x}}_{k / k} = {\hat{x}}_{k / k - 1} + {K}_{k} [ {y}_{k} - h ( {\hat{x}}_{k / k - 1} ) ] \qquad 16 ( b )$$

$${P}_{k / k} = {P}_{k / k - 1} - {K}_{k} {\hat{H}}_{k}^{T} {P}_{k / k - 1} \qquad 16 ( c )$$

$$Time Updating Expression$$

$${\hat{x}}_{k + 1 / k} = f ( {\hat{x}}_{k} ) \qquad 17 ( a )$$

$${P}_{k + 1 / k} = {\hat{F}}_{k} {P}_{k / k} {\hat{F}}_{k}^{T} + Q \qquad 17 ( b )$$

In other words, a Kalman gain K of an extended Kalman filter is calculated by applying the above-described covariance matrix Rt to a known expression shown in [Math. 3] above. Here, the covariance matrix Rt is the denominator term, so that the Kalman gain K becomes small as the matrix Rt becomes large. Then, the weight of observation is lowered with a decrease in the Kalman gain K.

As such, the estimation using the prediction points is emphasized more than the estimation using the observation points, which makes it possible to improve the object tracking performance as compared with a case where it is not.

### 4. Other Embodiments

Although the embodiments of the present disclosure are described hereinabove, however, as a matter of course the present disclosure is by no means limited to the above-described embodiments and may take a variety of forms.

(4a) The object tracking device according to the present disclosure can be applied to a self-driving system or a monitoring system for a vehicle or the like.

(4b) The object tracking device according to the present disclosure may be implemented by a dedicated computer including a processor and a memory and the processor is programmed to perform one or a plurality of functions implemented by a computer program.

Alternatively, the object tracking device according to the present disclosure may be implemented by a dedicated computer including a processor including one or more dedicated hardware logic circuits.

Further alternatively, the object tracking device according to the present disclosure may be implemented by one or more dedicated computers including a combination of a processor programmed to perform one or a plurality of functions and a memory with a processor including one or more hardware logic circuits.

Moreover, the computer program may be stored, as an instruction to be executed by a computer, in a computer-readable non-transitory tangible recording medium. An approach to implementing the function of the sections included in the object tracking device does not necessarily include software and all the functions may be implemented by one or a plurality of pieces of hardware.

(4c) The present disclosure may be implemented in a variety of forms in addition to the above-described object tracking device, such as a program for causing a computer of the object tracking device to function, a non-transitory tangible recording medium such as a semiconductor memory in which the program is recorded, and an object tracking method.

(4d) A plurality of functions of one component in the above-described embodiments may be implemented by a plurality of components or one function of one component may be implemented by a plurality of components. Moreover, a plurality of functions of a plurality of components may be implemented by one component or one function implemented by a plurality of components may be implemented by one component. Moreover, the configurations of the above-described embodiments may be partly omitted. Moreover, at least a portion of the configurations of the above-described embodiments may be added to or replaced with the configuration of another embodiment.

### Technical Idea Disclosed Herein

### Item 1

An object tracking device (1) configured to cause a sensor (5) to perform sensing of a surrounding environment in a predetermined cycle and track an object (3) that is a target based on information obtained by the sensing,
the object tracking device comprising a tracking processing section (9) configured to estimate a state quantity indicating a state of the object during a current cycle by using information regarding an observation point indicating the object obtained by the sensor,
the tracking processing section is configured to use, as the state quantity of the object, the state quantity regarding at least a position of the object and a shape of the object, and
the tracking processing section includes:
an observation point extractor (31) configured to extract, based on a state quantity of the object estimated during a previous cycle, the observation point obtained from the object during the current cycle;
a prediction point generator (33) configured to generate, based on the state quantity of the object estimated during the previous cycle, at least one prediction point at a predicted position at which the observation point is expected;
an aligner (35) configured to bring the observation point obtained from the object during the current cycle and the prediction point generated by the prediction point generator into alignment by scan matching,
a residual calculator (37) configured to obtain a correspondence point of the object at the predicted position corresponding to the observation point from the prediction point brought into the alignment with the observation point obtained during the current cycle, and calculate a residual between the observation point and the correspondence point; and
a state updater (39) configured to update the state quantity of the object based on the residual calculated by the residual calculator.

### Item 2

The object tracking device according to Item 1, in which,
the aligner is configured to:
extract, from among the observation point obtained from the object during the current cycle, the observation point on a contour of the object or near a predetermined range of the contour, and
use the extracted observation point for the scan matching.

### Item 3

The object tracking device according to Item 1 or Item 2, in which the aligner is configured to, in a course of the alignment by the scan matching, perform re-examination so that the prediction point observable by the sensor is selected from among the prediction point generated by the prediction point generator.

### Item 4

The object tracking device according to any one of Item 1 to Item 3, in which
the observation point observable by the sensor is a set of observation points, and
the aligner is configured to:
   determine a spatial extent of the set of observation points observable by the sensor, and
   not to perform the scan matching in a case where the spatial extent is equal to or smaller than a predetermined range.

### Item 5

The object tracking device according to any one of Item 1 to Item 4, in which
the observation point observable by the sensor is a set of observation points, and
the aligner is configured to:
   determine a spatial extent of the set of observation points observable by the sensor, and
   in a case where the spatial extent is equal to or smaller than a predetermined range, reduce a weighting of the observation point in updating the state quantity by using the observation point as compared with in a case where the spatial extent is not equal to or smaller than the predetermined range.

What is claimed is:

1. An object tracking device configured to cause a sensor to perform sensing of a surrounding environment in a predetermined cycle and track an object that is a target based on information obtained by the sensing,
the object tracking device comprising a tracking processing section configured to estimate a state quantity indicating a state of the object during a current cycle by using information regarding an observation point indicating the object obtained by the sensor,
the tracking processing section is configured to use, as the state quantity of the object, the state quantity regarding at least a position of the object and a shape of the object, and
the tracking processing section includes:
an observation point extractor configured to extract, based on a state quantity of the object estimated during a previous cycle, the observation point obtained from the object during the current cycle;
a prediction point generator configured to generate, based on the state quantity of the object estimated during the previous cycle, at least one prediction point at a predicted position at which the observation point is expected;
an aligner configured to bring the observation point obtained from the object during the current cycle and the prediction point generated by the prediction point generator into alignment by scan matching,
a residual calculator configured to obtain a correspondence point of the object at the predicted position corresponding to the observation point from the prediction point brought into the alignment with the observation point obtained during the current cycle, and calculate a residual between the observation point and the correspondence point; and
a state updater configured to update the state quantity of the object based on the residual calculated by the residual calculator.

2. The object tracking device according to claim 1, wherein
the aligner is configured to:
extract, from among the observation point obtained from the object during the current cycle, the observation point on a contour of the object or near a predetermined range of the contour, and
use the extracted observation point for the scan matching.

3. The object tracking device according to claim 1, wherein
the aligner is configured to, in a course of the alignment by the scan matching, perform re-examination so that the prediction point observable by the sensor is selected from among the prediction point generated by the prediction point generator.

4. The object tracking device according to claim 1, wherein
the observation point observable by the sensor is a set of observation points, and
the aligner is configured to:
determine a spatial extent of the set of observation points observable by the sensor, and
not to perform the scan matching in a case where the spatial extent is equal to or smaller than a predetermined range.

5. The object tracking device according to claim 1, wherein
the observation point observable by the sensor is a set of observation points, and
the aligner is configured to:
determine a spatial extent of the set of observation points observable by the sensor, and
in a case where the spatial extent is equal to or smaller than a predetermined range, reduce a weighting of the observation point in updating the state quantity by using the observation point as compared with in a case where the spatial extent is not equal to or smaller than the predetermined range.
